(19) United States
(12) Patent Application Publication
(10) Pub. No.: US 2007/0241060 A1
(43) Pub. Date: Oct. 18, 2007

(54) Hydrodynamic Homogenization

(76) Inventor: Frank R. Kolb, Elz-Marmerich (DE)

Correspondence Address: Chris Papageorge, 14625 S. Vermont #5, Gardena, CA, 90247, US

(21) Appl. No.: 11/572,689

(22) PCT Filed: Jul. 16, 2005
(86) PCT No.: PCT/EP05/07776

§ 371 Date: Jan. 25, 2007

(30) Foreign Application Priority Data
Jul. 26, 2004 (DE) 10 2004 036 181.9

(51) Int. Cl. C02F 1/34; B01D 21/30

(52) U.S. Cl. 210/748; 210/512.3

(57) ABSTRACT

The invention relates to a method, wherein agglomerates found in sludge suspensions of sewage purification are destroyed in a first step, whereby the agglomerates are broken up by means of particle-particle and particle-wall collisions by deflecting at least once the sludge suspension. In another step, all components found in the sludge suspension are mixed due to high wall shear stress owing to a high rate of wetting area with respect to the crossflown surface.

In the field of environmental protection technique, in many purification processes, sludges occur as pollution sink, such as in sewage purification. These sludges largely consist of a carrier liquid, generally water, and organic as well as mineral particles. The organic particles in the sludges are composed of individual or flakes of microorganisms and polymers, wherein they can be differentiated in the group of the natural biopolymers, so-called extracellular substances (EPS), and in artificial polymers, which are to largely assist in the purification process. The inorganic sludge components mainly consist of crystalline complexes and polymers. The polymer components of the sludges have active characteristics, whereby the Theological characteristics thereof and the dehydrating capability thereof can be critically influenced. In the organic sludges, the stabilization characteristics can be additionally improved and thus finally the amount can be minimized, in particular by means of the biopolymers.

The effects and interactions between the individual sludge components as well as their positive influence by the subsequently described invention are clarified for sewage sludges, which occur in the sewage purification.

In the sewage purification various sludges occur, such as primary sludge from the pre-clarification, secondary sludge from the activation and tertiary sludge from the precipitation. These sludges are stabilized in either aerobe or anaerobe manner. The anaerobe stabilization (digestion) is the most cost-efficient method from an equipment size of 20,000 EGW, such that it is predominantly employed. In these equipments the circulation and thus an equalization of the reaction container content by mixing, for example with stirrer, gas pressing or pump circulation, is allowed, wherein complete mixing cannot be realized due to the size of the reaction containers and the geometrical formation thereof. In these equipments the prior art is characterized by supply and recirculation lines, in which the methods for mixing and circulation of the sludges can be applied or the devices for it can be interposed, respectively.

The different sludge types have great differences in their composition, such that floating sludge has a solid content of less than 0.5%, and in digestion a mixed sludge is employed, which has a solid content of 6 to 8%. Independent of their absolute composition, all of the sludges are composed of a carrier liquid, water in the sewage purification, microorganisms, biopolymers, polymers, organic (fats, proteins etc.) and inorganic (nitrogen compounds, phosphates etc.) pollutants as well as mineral substances (sand, chips etc.). These components form agglomerates within the carrier liquid, in which the microorganisms aggregate to flakes with a part of the biopolymers and the other substances are present in the carrier liquid as particles or dissolved. The flake structure of the microorganisms is heterogeneous, such that the flakes form a cluster of spherical and rod-shaped units. Due to the aerobe and/or anaerobe biochemical conversion process gas bubbles are generated (aerobe: mainly nitrogen and oxygen from ventilation, anaerobe: mainly methane and carbon dioxide), which mostly adhere to the rod-shaped microorganisms and float them due to the specific volume to surface ratio. By this procedure, the microorganisms are removed from the active purification process and hinder it additionally by the resulting flotation coats (floating sludge in the activation and post-clarification, foam in the digestion, bulking sludge in the post-clarification).

The problems of flotation coat formation and thus the removal of the microorganisms from the active purification operation as well as the improvement of the entire purification process can be solved or achieved by homogenization of the sludges both in the anaerobe and in the aerobe stages, respectively. By a complete homogenization, the surface for the mass transfer is increased, the biopolymers and the pollutants are made completely accessible for the microorganisms for biological conversion, and the rod-shaped microorganisms are liberated from adhering gas bubbles, such that they can no longer float up.

That these acting mechanisms can be achieved, is confirmed by examinations for disintegration, thus the destruction of the microorganisms up to cell decomposition (“Verfahren und Anwendungsgebiete der mechanischen Klärschlammdesintegration”, Korrespondenz Abwasser, vol. 47, 4/2000, page 570-576; “Verfahrensvergleich und Ergebnisse der mechanischen Klärschlammdesintegration”, Korrespondenz Abwasser, vol. 48 3/2001, page 393-400; “Mechanische Zerkleinerung von Bläh-und Schwimmschlämmen”, Wasser-Abwasser-Praxis, 3/99, page 25-31). However, in order to achieve these results, energy inputs of more than 1,000 kJ/m³ of sludge to be treated are required. The employed methods are only partly suitable for conversion to the technical scale due to their low operation stability (high-pressure homogenizer), their high maintenance intensity (stirrer ball mill) or costs (ultrasonic), because they are all designed for a complete cell decomposition.

Another group of mechanical treatment methods has a flow channel (DE 202 20 566 U1, DE 102 14 689 A1), which is similar to a Laval nozzle in its formation. Therein, alteration in the sludge suspension is to be caused by hydrodynamic shear fields. By the shear fields, shear stresses are to be used for destruction of the microbial structure and cavitation is to be generated such that the cell walls of the microorganisms can be decomposed. However, disintegration of microorganisms in purely hydrodynamic way requires a relatively high energy input, since high flow velocity in a tubing restriction must be generated for the formation of the cavitation bubbles in order to lower the static pressure below the vapor pressure due to the Bernoulli equation. Thereby, the pressure loss over-proportionally increases and the energy related to mass becomes higher as well as the throughput performance becomes lower. Further, it has to be taken into account that the cavitation bubbles cause a high noise level upon their implosion, such that expensive and cost-intensive noise encapsulation is required and they have only a small penetration depth into the carrier liquid, such that destruction of the microorganisms can only be effected to small extent (in the technical scale 3-10%, more gas-less sludge, “Wasser-Luft-Boden”, 9/2004, page 18/21). A variation of the ratio of special groups of microorganisms (filamentary compared to flake-forming ones) in the sludge suspension by shear fields as set out in DE 101 55 161 A1 seems to be impossible. Since sufficient selective characteristic quantities with respect to the physical parameters of microorganisms in mixed biocoenoses are not known to realize a regulation of the shear fields in this manner.

Therefore, the object of all methods developed up to now is to improve the process of sludge treatment by destruction of the microorganisms in order to be able to convert the organic components better and faster. Up to now, the various Theological characteristics as well as the positive contribution of all microorganisms and polymers to the conversion of the pollutants in the sludge treatment have not been sufficiently considered.

Depending on the solid content the rheological characteristics of the sludges can be differentiated in a NEWTON and a non-NEWTON flow behavior with a dry matter content of about 0.5% (less than 0.5% NEWTON flow behavior), wherein the term non-NEWTON flow behavior in these explanations is to be interpreted wider and is to include all of the other flow characteristics. Since sewage sludges have a distinct thixotropic behavior from a certain solid content, these mechanisms are particularly taken into account.

With greater dry matter contents of about 0.5%, the viscosity decreases with increasing shear rate (homogenization) (“Einfluss der Viskosität auf den Sauerstoffeintrag”, Final Report, Max-Buchner-Foundation, identification number 2281, 11/2003). From a solid content of about 2.5% sewage sludges have thixotropic characteristics meaning that the sludge suspension again reforms to its initial structure and thus viscosity without shear stress (“Rheologische Charakterisierung flüassiger Klärschlämme”, Korrespondenz Abwasser, vol. 44, 9/1997).

This rheological phenomenon describes the complex interactions between molecules or particles for pseudo-plastic liquids, which become less viscous under the influence of increasing shear stresses. Mostly, an orientation and de-looping of filament molecules (polymers) or the particle shape change of suspended particles in the flow direction (sludge flakes) is underlying the behavior. Since the various partial components of the sludges have surface-active characteristics, the mutual shiftability of these components can be influenced and destroyed by compression and shear forces by means of special chemical/physical binding forces.

The binding forces form a three-dimensional framework structure in the sludge suspension, which is also referred to as a “gel” due to its characteristics. If the gel decomposes, the viscosity decreases until it has reached the smallest possible value, the “sol state”, with a given constant shear stress. The change from the gel to the sol state and vice versa is arbitrarily often reproducible in thixotropic suspensions (“Einfuhrüingen in die Rheologie”, Gebrüder Haake GmbH, Karlsruhe, 2000). These state changes can only be interrupted by the partial or complete destruction of the partial components, by means of which the sludges lose their thixotropic characteristics.

Additionally, for changing the “gel matrix” of the sludge, additionally, also the cavitation can be employed. This treatment method has not been considered in more detail in the previous examinations, since the objective of the known cavitation methods was always a cell destruction. However, by means of the controlled employment of the flow-mechanical cavitation the extracellular substances (EPS) and the “synthetic” polymers can specifically be altered. The special effect influences the active centers of the EPS and of the polymers, such that the gel structure of the sludge is dissolved thereby. In contrast to the above mentioned methods, for these alterations it is only required to slightly undershoot the vapor pressure. The slight, also temporary undershooting of the vapor pressure causes particularly small cavitation bubbles (“Analogie zur thermischen Verdampfung von Flüssigkeitsgemischen, Grundoperation der chemischen Verfahrenstechnik”, 10^{th} edition, Leipzig 1994). The implosion of these vapor bubbles results in damage of the EPS and polymers, whereas at the same time the implosion noises are substantially reduced. An expensive noise encapsulation does not have to be effected when using this cavitation technique, which is in respect of its vapor bubble appearance similar to that of ultrasonic cleaning bathes.

In the following embodiments, it is often distinguished between NEWTON and non-NEWTON flow behavior, wherein the implementations for the non-NEWTON flow behavior can be transferred to the thixotropic behavior of sewage sludges from a solid content of more than 2.5% (if the thixotropic behavior is the focus of the considerations, this is indicated). However, the improved flow behavior with increasing homogenization also results in an improved mass transfer rate, since all of the involved components are available. This becomes particularly clear by the enzymes contained in the organic sludges. The activity of the enzymes can be increased even due to small mechanical treatment forces (Examinations on the KA Kitzbühl, unpublished).

Further, it has to be considered to a larger extent than hitherto that particularly in organic sludges all of the microorganisms and polymers make a positive contribution to the conversion of the pollutants, if a sufficient mass transfer surface is available and if these substances can be kept dissolved in the carrier liquid.

The object of the present application is to propose a method and an apparatus for performing the method, which results in a low-cost and efficient dissolution of the agglomerates (microbial flakes, polymer clusters etc.) and thereby in the destruction of the original sludge structure as well as in a complete mixing of these partial components into the carrier liquid and thus in homogenization as complete as possible. The homogenization forms the basis for an improved mass transfer of all components in organic sludges.

For this purpose, a method is proposed, which is comprised of a pressure generator having a treatment unit and at least one inflow and/or outflow as well as a device with different functional stages disposed therebetween. The flow through the stages can be arbitrarily effected, however, in the sense of a homogenization of the sludge suspension as complete as possible, it is advantageous, if first the stages for destructing the agglomerates and subsequently the stages for mixing the polymers, EPS and the microorganisms into the sludge suspension are flown through.

At least one stage in the method is formed such that the different particle agglomerates are destructed and mixed into the carrier liquid by hydro-mechanical turbulence. In the following explanations this stage is referred to as disagglomeration stage. The destruction of the agglomerates in this stage is effected by deflecting the flow, and in consequence of this, exclusively by particle-particle or particle-wall collisions, respectively. At the locations of deflection of the channel hydro-mechanical rupturing and deflecting vortexes emerge, which cause a mixing of the resulting components into the sludge suspension. The angles within the channel are adapted to the rheological conditions of the respective sludge and particularly depend on its viscosity.

The intensity of the mixing in this stage is determined by the number of locations of deflection and the operation of the pressure generator. With an increasing number of the locations of deflection, the releasing vortexes and thus the intensity of the mixing further increase. A homogeneous suspension is achieved with increasing pressure, since the effect of the disagglomeration and fragmentation by particle-particle and particle-wall collisions is improved.

In at least one further stage the mixing of the sludge suspension with all of the components, in particular with the microorganisms, the enzymes, the extracellular substances and polymers, is performed in at least one gap. In the following explanations this stage is referred to as homogenization stage. For the mixing in the gap the wall shear stress is utilized as driving force. In contrast to other methods, the treatment of the sludge is not achieved by a cross-sectional restriction with high flow velocities, but the particularly great ratio of the wetted to cross-flown area is employed, in order to thereby increase the wall shear stresses and the penetration depth into the medium. For the mixing due to the wall shear stresses, Reynolds numbers of less than 80,000 are sufficient for the flow-through in this stage such that no full turbulent flow is achieved and the pressure losses can be minimized.

With a high mineral portion of more than 0.5% the surfaces have to be hardened so that the channel is not destroyed by the particle collisions. This method is particularly advantageous in that in the flow there are no moved parts being prone to malfunction, but the effect can solely be attributed to hydrodynamic influence quantities.

Advantageous further embodiments of the method result from the dependent claims.

A further embodiment consists of an at least two-stage method consisting of at least one disagglomeration and one homogenization stage. The flow-through areas are formed such that virtually no increase of the flow velocity is effected.

If the viscosity of the sludge is at least 5 times greater than that of water, at least one deflection angle should have at least 90° in the disagglomeration stage. With lower viscosities, the deflection angle can be chosen to be smaller than 90°.

In the homogenization stage the mixing of the components is performed in at least one gap. The flow-through area of the gap or the gaps, respectively, is chosen such that no increase of the flow velocity occurs with a viscosity of the medium of less than 5 times that of water, wherein the width to length ratio is advantageously at least 1 to 10. With greater viscosity of the medium the number of the cross-flown gaps can be increased or the gap areas can be reduced in flow-through direction, such that the influence of the wall shear stresses can be increased for mixing.

In the homogenization stage the intensity can be further improved by the gap having the shape of an annular gap. By means of multiple annular gaps fed in parallel, the effect of the penetration depth of the wall shear stresses on the particulate and dissolved components in the main mixing zone is increased with the same average flow-through velocity in a particularly advantageous manner.

A further embodiment of the claims is that the sludge suspension is deflected 2-5 times in the disagglomeration stage. The number of locations of deflection in this stage is always a trade-off between the pressure losses by compression and friction forces and the destruction of the agglomerates. With a deflection of 2-5 times, the pressure losses are minimized and simultaneously about 80 to 85% of the agglomerates are treated.

By means of the width to length ratio of at least 1:10 of the gap in the homogenization stage, independent of the actual geometrical dimensions thereof, the hydraulic diameter is nearly halved compared to a geometry with identical flow-through area and a width to length ratio of about 1:1. In addition, the Reynolds number and the flow losses decrease by the lower hydraulic diameter with the same flow velocity. Since the flow velocity is constant for both geometries, the specific influence of the wall shear stresses on the sludge suspension is substantially increased with a ratio of 1:10. For reasons of operational safety of the method, the geometrical ratio cannot be arbitrarily increased, since particles, the diameter of which is greater than the width of the gap, would occlude it.

The dissolution of the agglomerates of microorganisms and/or polymers can be effected in mechanical or hydraulic way. In a further embodiment, the disagglomeration stage is realized by a hydraulic turbulence system in that the interior surface of a tube is provided for example with spiral grooves or the tube has a rough surface in hydraulic sense, such that the flow obtains twist impulses or release vortexes are generated, which result in the destruction of the agglomerates. In doing so, the geometrical dimensions should be formed such that the flow velocity is not greater than 4 m/s for abrasive reasons (“Grundoperationen der chemischen Verfahrenstechnik”, 10^{th} edition, Deutscher Verlag für Grundstoffindustrie, Leipzig, 1994), and the Reynolds number is not greater than 80,000 for hydraulic reasons (full turbulent flow results in the highest pressure losses).

A further embodiment of the application consists in a separation between the disagglomeration stages and the homogenization stages, wherein for viscosity values up to 5 times than that of water the disagglomeration stage can be composed of at least one receiver container or reservoir having at least one stirring means such as for example a fast operating propeller stirrer. This embodiment represents a low-cost solution since the pressure generators can be optimally adapted to their respective task, and thus with the same throughput performance lower electrical powers are required. However, the energy input by the stirring means in the disagglomeration stage is only sufficient for mixing the suspension and for destructing greater agglomerates at the blade surfaces of the propeller. Therefore, a second pressure generator is required for at least one homogenization stage for resulting in a high homogenization degree.

Another embodiment of the method influences the homogenization degree of the sludge suspension in such a manner that with changing hydraulic boundary conditions caused by varying volume flows the homogenization degree remains nearly constant. This is achieved in that at least one of the two partial areas (inner part, outer part) of at least one of the stages is movably supported. Thereby, the flow-through area can be automatically varied via the flow pressure and may be increased with increasing volume flow or be decreased with falling volume flows.

In order not to require additional flow pressure for adjusting the flow-through areas, in a further embodiment of the method the adjustment of the partial areas of the respective stages can also be effected by a separate drive acting purely mechanically, electrically, hydraulically or pneumatically. The characteristic parameter for positioning the partial areas can for example be the volume flow or the solid content of the sludge suspension.

If in the apparatus the channel of a stage is not formed linearly, but concentrically to the supply opening, a particularly compact unit may be arranged, or with the same dimensions of the linear and concentric unit, the latter may be operated with higher throughput performances. For the further embodiment of the method, it is then of particular hydraulic and manufacturing technique advantage, if the further stage is formed as an annular gap.

For mixing polymers and microorganisms into the sludge suspension, the annular gap as homogenization stage offers the advantage of nearly halving the equivalent hydraulic diameter compared to other geometries, in particular compared to a restriction of the channel. Thereby, in this further embodiment the influences of the wall shear stresses can be improved. This effect can advantageously be increased by the parallel connection of multiple annular gaps.

The methods set out so far did not directly have the object to increase the average velocity within the method or by the apparatus, respectively. In this further embodiment of the method, the average flow velocity is specifically increased in order to increase the influence of the wall shear stresses and to improve the homogenization of the sludge suspension. For this purpose, the cross-section of the annular gap of the homogenization stage is decreased such that at least a doubling of the velocity results. The increase of the wall shear stresses can especially be employed for sludges with high solid contents of for example more than 4%.

During the flow through the apparatus, a pressure is exerted on the sludge suspension. This flow pressure can be employed for increasing the homogenization, if a relaxation may take place in an particular zone, which can be arranged after or within the respective stage. In this further embodiment, the relaxation zone is preferably realized at the end of the homogenization stage. For this purpose, the flow cross-section is expanded suddenly and without transition after the homogenization stage. In this expanded region, an additional mixing of the suspension takes place by means of the pressure release.

For the homogenization of a suspension, the rheological characteristics thereof are of vital importance, in particular the viscosity and the flow behavior under force effect. The higher the viscosity, the more intensive the destruction of the agglomerates and the mixing thereof into the carrier liquid have to be effected. In sludge suspensions, for example in the sewage purification, the viscosity increases with increasing solid content, such that above a solid content of about 2.5% TS the viscosity has multiplied more than 5 times. In order to achieve in these suspensions comparable homogenization degrees as in sludges of low viscosity, the method has to be applied at least twice to the suspension.

By means of the intramolecular forces of the polymers and/or the microorganisms, a great part of these sludge suspensions has a non-NEWTON flow behavior. In this flow behavior, the viscosity forces are very high, mainly at the beginning of a treatment (exception, e.g. rheopective behavior does however not occur in sludge suspension in the mentioned regions), such that the method has also to be applied at least twice to the sludge suspension to be able to achieve a sufficient homogenization.

With increasing solid content the intramolecular forces become higher, such that the non-NEWTON flow behavior transforms such that the suspension has a thixotropic behavior. In order to prevent the thixotropic behavior by the application of the further embodiment of the method as long as possible, the method has to be applied multiple times to the suspension, particularly advantageously about 5 times.

If the method for homogenization has been applied multiple times to the suspension, the original viscosity and in association therewith the gel structure of the suspension recovers with increasing rest period. This return or recovery can largely be prevented in a low-cost manner by connecting a mixing container downstream the homogenization unit. By stirring the suspension with a mixing means in the mixing container, wherein the mixing means has a substantially lower energy input than the upstream homogenization unit, it is prevented that the gel structure is able to completely regenerate again.

There is another possibility for additional elimination of the thixotropic behavior of the sludge suspension, which is the destruction of the gel structure by means of the treatment. Polymers and the EPS in the sludges constitute the basis for the gel structure. For this purpose, the cavitation as set out in the further embodiment of the method is only increased that much so that the polymers and the EPS are destroyed by the pressure peaks during the collapse of the vapor bubbles. In this method step the energy density is not as high as when cleaving the microorganisms, since only the macromolecules in the sludge suspension have to be destroyed to achieve a permanent damage of the gel structure.

Since the sludge suspensions to be treated may have varying solid concentrations, it is required to control the pressure generator in order to achieve an equally good homogenization by the method. For controlling the pressure generator the volume flow and the pressure are particularly suitable, wherein both the input and output pressure and the pressure differential may be used as control variable in the further embodiments of the method.

A large part of the sludge components comprises surface-active characteristics. These characteristics are characterized by active centers in the molecular structure of both the polymers and the microorganisms. By formation of agglomerates, parts of the active centers and of the required mass transfer surface, in particular of the microorganisms, are lost, such that the reactivity of the components is not completely exhausted. This knowledge about the interior structures results in a further embodiment of the method, in which only a part of the entire sludge suspension is treated. Thus, by means of the homogenization the active centers again are almost completely exposed and the mass transfer surface is increased, such that upon mixing with untreated sludge the reactivity of the entire mixed sludge can be positively influenced. Thus, this further embodiment of the method represents a particularly low-cost solution, in particular in the treatment of great sludge amounts.

For the employment of the apparatus in the method the effect of the individual stages and the operational stability are of great importance. In order to increase the operational stability the apparatus is constructed in at least two stages to perform a destruction of the agglomerates in the first stage. Thereby, the structure of the sludge suspension becomes finer and the average particle diameter becomes smaller. In a further stage a continuing mixing and homogenization as well as an improvement of the flow characteristics is now achieved by wall shear stresses.

By means of the arrangement of the disagglomeration before the homogenization the danger of occlusion of the apparatus by sludge components is minimized and the operational stability is increased.

By means of the angle in the supply and/or discharge channel, a deflection of the sludge suspension is effected, the change of direction results in an impact of the agglomerates on the surrounding channel walls. A simple and low-cost embodiment of the channel can for example be effected by a tube, wherein the tube cross-section can be arbitrarily selected (e.g. square, rectangle, circle, polygon). The shape of the tube has to be formed such that the flow direction of the sludge suspension permanently changes. By means of this change, a twist impulse is induced in the flow, such that the agglomerates hit the walls of the tube.

The simplest embodiment, such that a constant change of direction of the sludge suspension is caused, is a helical design of the tube. Another advantageous design has a zigzagged shape.

Another measure for destructing the agglomerates may be effected by changing the inner surface of the flow channel. For this purpose, in a further embodiment, the tube inner wall is formed such that release vortexes form during flow-through with the sludge suspension. The vortexes can for example be induced by helically running grooves in or by fitted welding globules on the inner wall. By means of the vortexes the agglomerates are destroyed in hydraulic way and the sludge suspension is premixed.

If the deflection angles in the disagglomeration stage are dimensioned too small depending on viscosity and solid content of the sludge suspension, the stage can clog and hinder or prevent the homogenization, respectively. Therefore, for example with high viscosities, the angles should be decreased from deflection to deflection such that at a large deflection angle a part of the agglomerates can be broken up and the viscosity can be lowered. At the subsequent locations of deflection the angles become increasingly smaller, such that the agglomerates are gradually destroyed, the viscosity is lowered and the mixing into the carrier liquid is effected. By means of this approach the operational stability is increased and a clogging of this stage is prevented. This approach shows particularly clearly why the homogenization should be effected in at least two stages such that in the homogenization stage there is already a partially homogenized suspension and no clogging by means of the sludge particles can occur therein.

With low viscosities similar to those of water the sludge components can follow the flow paths at large deflection angles, and thus a destruction of the agglomerates cannot be sufficiently effected. In a further embodiment of the apparatus, therefore, with low viscosities, in the stage for destructing the agglomerates an angle between the locations of deflection is selected in a range of 80 to 110°, in particular advantageously of 90°. By this angle, the suspension is directly pressed onto a wall at the location of deflection and the agglomerates are destroyed by wall-particle and additionally by particle-particle collisions. At the same time, a good mixing of the destroyed agglomerates into the carrier liquid is effected by the vortex releases.

In non-NEWTON flow behavior and/or thixotropic behavior, the flowability of a suspension is increased with increasing mechanical stress and the viscosity is lowered. Since the force effort and thus the pressure loss increases over-proportionally to the stress strength of the suspension, in this embodiment of the apparatus the deflection angles are successively decreased in the disagglomeration stage. Thereby, a pre-liquefaction of the suspension is achieved with a force effort as low as possible and this pre-liquefaction is further increased at the next deflection with about constant pressure loss. At the same time, with the increase of the liquefaction, the destruction of the sludge agglomerates is effected at the impact surfaces of the respective locations of deflection. In sludges with low viscosity and solid concentrations such as for example floating sludge it is of particular relevance to operate in a hydraulically optimum range for the effectiveness of the homogenization. This range may be changed externally controllable or be changed automatically. In a further embodiment of the apparatus at least one stage is two-partly formed comprising an interior and exterior part, wherein at least one part of the stage functions as a pressure plate. By means of the flow pressure of the supplied sludge suspension the distance between the two parts of the stages is automatically adjusted, and thus optimum hydraulic boundary conditions are almost always provided for the homogenization.

For the construction of a compact treatment unit and for minimizing pressure losses during the flow through the apparatus radially symmetric systems are more suitable than linear ones. For this reason, in a further embodiment the sludge suspension of the apparatus is centrally supplied and spreads concentrically around this supply position within the apparatus. The transition between the individual stages can be effected seamlessly due to the radially symmetrical construction. By means of this construction of the apparatus, it is possible to achieve particularly high energy densities with small geometrical dimensions.

A particularly compact unit results, if the two functional stages are realized in one stage. This can be achieved in that the stage consists of an outer and inner part, wherein the inner part is composed of a block being advantageously arranged centrically in the outer part. The shape of the block is formed such that partitioning and deflection of the sludge suspension within the supply results, and subsequently an annular gap is for example formed by effecting mixing and homogenization of the sludge suspension by the wall shear stresses.

Besides the efficiency of an apparatus in its special application, also attention is particularly directed to the low-cost manufacture thereof. In the field of steel and stainless steel production, different geometrical shapes of solid materials and tubes having different market prices are produced. If, for example, two equal shapes of a tube (as an outer shell) and of a solid material (as a core) are connected to each other such that a gap is generated between them, this construction can be employed as a homogenization stage. The substantial advantage of this construction is that no machining and thus expensive reworking is required. Depending on the market price, different geometries could be employed for this, which have similar hydraulic characteristics in the combination of outer shell and core.

In particular with high solid contents of about 4%, the operational safety of an apparatus has to be particularly considered. For this purpose, in a further embodiment of the device the stages are constructed of an inner and outer part, of which at least one part is movably supported and formed as a pressure plate. Upon increased pressure generation in the apparatus, which indicates a clogging of the channels, at least this part of the stages may displace. Thereby, the flow cross-sections are increased and the beginning clogging of the channels can be undone. In order to technically implement this self-cleaning mechanism of the apparatus, the geometry of the homogenization stage should be formed trapezoidally, wherein the expansion of the trapezoid is effected in flow direction. In order to keep the pressure losses low, the flow-through cross-sections are kept constant, wherein due to the trapezoidal longitudinal section of the main mixing zone the equivalent hydraulic diameter becomes increasingly smaller and thus the influence of the wall shear stresses as well as the degree of the homogenization become increasingly greater.

In order to avoid the additional pressure loss for automatic adjustment of the movable pressure plate, it can be adjusted by an externally applied force input. For controlling the pressure plate adjustment, the volume flow and/or the solid concentration and/or the viscosity may be queried and used as parameter.

A further increase of the wall shear stresses can be achieved by a segmentation of the homogenization stage.

In a particularly advantageous manner for a complete mixing of the sludge suspension the segments of the homogenization stage can further be formed as nozzles. This further embodiment of the method is suitable in a particular advantageous manner for sludge suspensions with high solid contents and a small particle size spectrum.

If the segments are formed such that it is fallen below the vapor pressure of the carrier liquid is undershot, the cavitation can be utilized as mixing force in addition to the hydrodynamic mixing forces.

In order to further increase the homogenization in a further embodiment of the apparatus the flow-through area of the homogenization stage is divided in at least one further zone. In this zone, a cross-sectional expansion takes place, such that the previously applied pressure forces are abruptly removed from the agglomerates in the carrier liquid. By means of this relaxation, turbulences are induced in the expanding cross-section, which effect improvement of the homogenization.

With high viscosities and/or thixotropic behavior of the sludge suspension the sole relieve of the pressure forces in an expanding cross-section is not sufficient. Therefore, in a further embodiment of the apparatus at the exit of the first zone of the homogenization stage the pressure falls below the vapor pressure and a mixing space is achieved by the cross-sectional expansion, in which the implosion of the vapor bubbles can specifically be utilized for homogenization.

If the solid contents in a sludge suspension are further increased, for example by a preceding dehydration, the application of an apparatus for homogenization can thus no longer be sufficient to achieve a high homogenization degree. In this case, two or more of the homogenization units may each be connected with a pressure generator to a serially operated unit. By means of the repeated treatment, virtually all of the agglomerates are destroyed and a large homogenization is achieved.

If the apparatus is incorporated in a concept for sludge treatment, thus, the incorporation of the treatment unit is necessary. A particularly simple and low-cost possibility is given, if the treatment unit is provided with flange connections, such that it can be incorporated in an existing tubing.

By means of the applied method, pressure impulses are effected by the pressure generators as well as by the changes of the sludge suspension, such that the vibrations caused by the pressure impulses have to be absorbed in one treatment concept. In this case, the apparatus can be additionally provided with at least one compensator for minimizing the vibrations.

In the following, the invention is explained by way of graphic representations, which show:

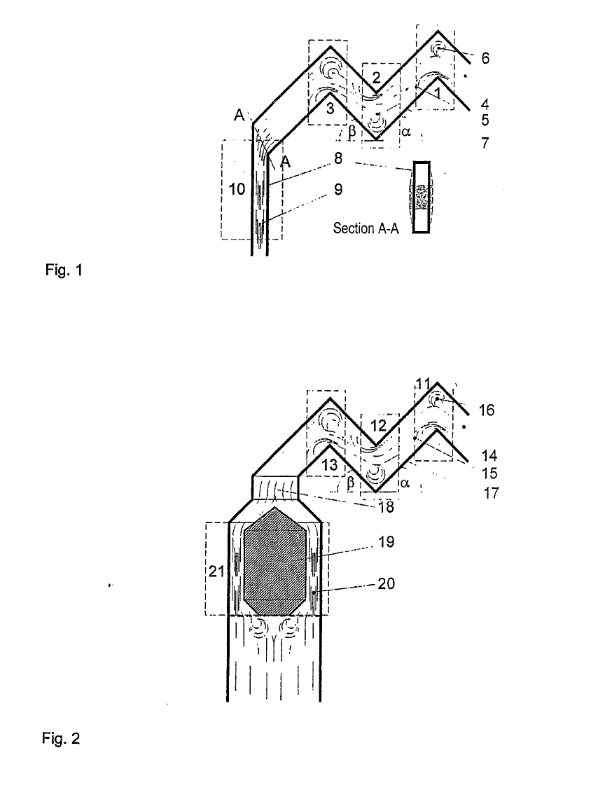

FIG. 1 a schematic diagram of the method from flow-dynamic view with a rectangular flow channel both in the disagglomeration and the homogenization stage,

FIG. 2 a schematic diagram of the method from flow-dynamic view with an annular gap in the homogenization stage,

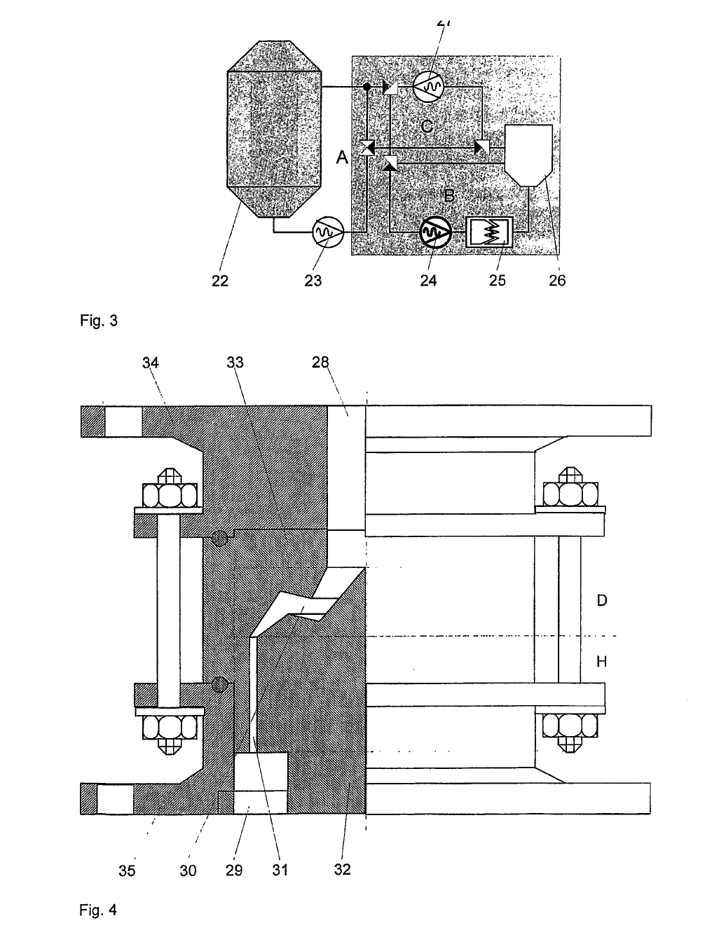

FIG. 3 a schematic diagram of the method for a sludge suspension having thixotropic characteristics for partial flow treatment and a downstream stirring container to hinder the recovery of the original viscosity,

FIG. 4 a schematic diagram of a constructive implementation for a two-part apparatus for the homogenization of a sludge suspension,

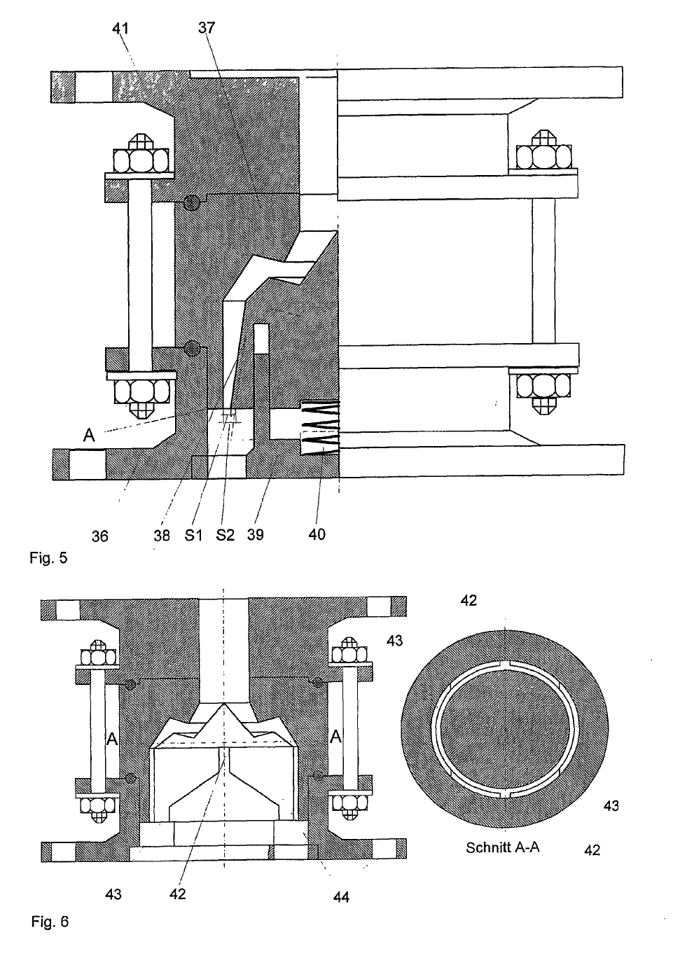

FIG. 5 a schematic diagram of a constructional implementation for an apparatus for the homogenization of a sludge suspension in shiftable design with trapezoidal longitudinal section,

FIG. 6 a schematic diagram of a constructive implementation for an apparatus for the homogenization of a sludge suspension with segmented annular gap,

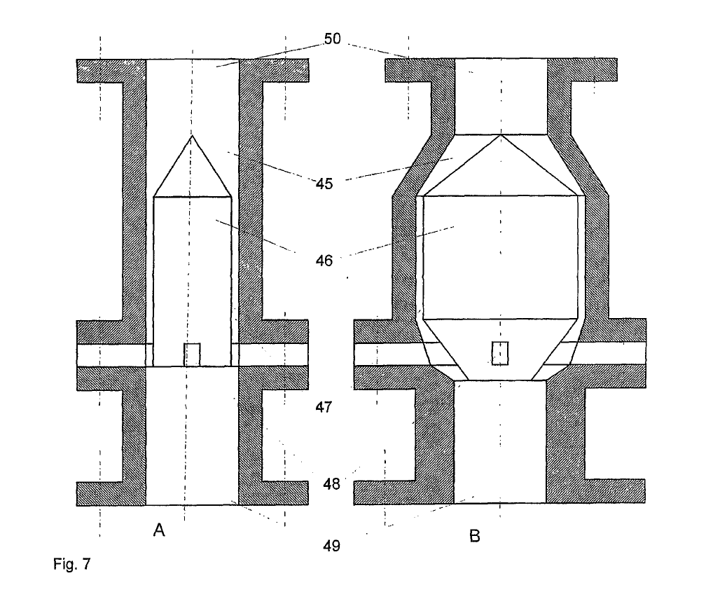

FIG. 7 a schematic diagram for an apparatus for the homogenization of a sludge suspension with variable and constant average flow velocity.

FIG. 1 shows the method and apparatus principle of the homogenization of sludges in the sewage purification. The homogenization unit is composed of a disagglomeration stage 7 and a homogenization stage 8, wherein the disagglomeration stage has a square cross-section and the homogenization stage has a rectangular cross-section. The deflection of the sludge suspension is effected at three locations of deflection 1, 2, 3, at which the individual flow filaments 4 form themselves to hydrodynamic cells (grey shaded) with dissolution 5 and deflection vortex 6. All locations of deflection are formed in this alternative with the same angle (=180°—a (supply channel)—b (discharge channel)). At the location of transition (section A-A) between the disagglomeration and homogenization stage, the square flow cross-section is converted into a rectangular cross-section, and thereby the ratio of wetted to cross-flown area 10 is increased. The alteration of this hydraulic characteristic parameter results in an increase of the wall shear stresses 9, effecting an improved homogenization of the sludge suspension.

FIG. 2 shows a similar implementation 11-17, wherein the separation 18 between the stages is more clear. The cross-section of the homogenization stage has an annular gap. The shape of the annular gap is generated in the channel for the sludge suspension by a rotationally symmetric core 19, which is mounted on a carrier plate having passages for the suspension. This implementation alternative effects a further increase of the wetted to the cross-flown area 21 such that the wall shear stresses 20 and their effect on the sludge suspension can be increased.

In FIG. 3, a method for partial flow homogenization of sludge suspensions with thixotropic characteristics is shown. The sludge suspension is recirculated by means of a pump 23 within the digestion container 22 (A). From the recirculation flow a partial flow of the sludge suspension is removed by the pump 24 and homogenized in the treatment unit 25 and conveyed into the container 26 for further treatment (B). In order to prevent a recovery to the original viscosity of the sludge suspension, this is mixed by a mixing means (in this case with the pump 27) such that the gel structure cannot completely re-form again (C). After the first treatment with the pump 24, the suspension is again removed from the container and re-fed through the treatment unit. If a sufficient homogenization of the suspension is achieved, this can be again fed back into the digestion container by means of the recirculating pump 27.

FIG. 4 shows an apparatus for homogenization, in which the sludge suspension is applied centrally to a concentrically formed disagglomeration stage through the supply opening 28. The disagglomeration stage (D) and the homogenization stage (H) are formed in two parts, consisting of a fixed outer part 33 and inner part 32. The disagglomeration stage is composed of an annular channel, in which the suspension is deflected twice and subsequently fed into the homogenization stage with its annular gap 31 that has a constant cross-section. The carrier plate of the inner part provided with openings 29 is pushed into the lower housing 35, which is connected to the outer part and the upper housing 34 through a tension rod connection.

The apparatus in FIG. 5 is similarly constructed as in the previous implementation, however, here the inner part has been designed axially displaceable and with a trapezoidal longitudinal section of the annular gap 38 in the region of the homogenization stage. The inner part of the apparatus is fitted onto the carrier plate 39 and freely movable within the guide groove. By means of a spring member 40, the inner part is pressed towards the supply opening. According to the sludge volume flow, the flow-through areas can vary by the flow pressure via the movable inner part. Thereby, the flow-through area varies in the region of the disagglomeration stage over the entire region of the movement path up to the stop point on the carrier plate. This adaptation to varying volume flows in the region of the disagglomeration stage increases the operational stability, in particular with thixotropic sludge suspensions, since by means of the changed channel cross-section, the forces for the agglomerate destruction are kept high, the viscosity is lowered and at the same time clogging of the stage can be largely avoided.

The exit area of the homogenization stage remains constant up to a movement distance A with a gap measure of S1. In a greater volume flow or with increasing solid contents causing a higher pressure loss during the flow-through, the inner part displaces beyond the movement distance of A towards the carrier plate, such that the exit area in the homogenization stage has increased up to the stop point to the gap measure S2. In order to keep the homogenization degree high, the homogenization stage is operated with a smaller annular gap area, as far as the flow pressure on the inner part allows. If the flow pressure becomes that high such that possibly a clogging of the stages could result, also the flow-through area of the homogenization stage increases for avoiding the clogging. This implementation results in a high operational stability of the method.

FIG. 6 shows an implementation of the apparatus, in which the homogenization stage is segmented and implemented with varied flow-through cross-sections. The leg 42 of the inner part abuts the wall of the outer part. The cross-sectional area of the leg expands such that the exit area in the annular gap decreases in flow-through direction. At the exit of the homogenization stage, the exit area 43 has approximately halved compared to the entry area. By means of this implementation, the ratio of wetted to crossflown area can be increased and the effect of the wall shear stress for homogenization of the sludge suspension can be improved.

FIG. 7 shows two different implementations, which can be manufactured very cost-efficient and which are formed such that in the alternative A the flow velocity varies and in alternative B there is virtually a constant average flow velocity during the flow-through. The supply opening 44 of the housing connects to the carrier plate with the legs 48 to the inner part. The deflection of the sludge suspension is effected in the region 45 of the inner part, and at the end of the apparatus the exit cross-section 49 has again reached the same size as the entry cross-section.

Alternative A can be employed with low viscosities and solid contents of the sludge suspension, such as for example with floating sludge. A clogging of the apparatus has not to be expected with these sludges due to their rheological and particle system characteristics. By means of the varying geometrical and thereby also hydraulic characteristics, the agglomerates are broken up and destroyed at the cone-shaped surface of the inner part and are mixed into the suspension in the region of the annular gap.

In alternative B, the sludges can have higher viscosities and solid contents, such as for example excess sludge. The pressure losses are minimized by the virtually constant flow velocity and the destruction of the agglomerates is mainly effected by impact. The homogenization is again effected by increase of the wetted to crossflown area ratio in this implementation.

1. Method for homogenizing sewage sludges for improving material conversion of the components in chemical and/or biochemical way, in particular for treating organic components in sewage purification, characterized in that
by means of a pressure generator a sludge suspension is conveyed into a device, wherein the device is formed such that flow is deflected at least once (1, 2, 3) and particles hit a wall at location of the deflection, such that agglomerates are destroyed, their surface area is increased and they are mixed into the suspension by hydrodynamic releasing vortexes (6) at the location of deflection, and conveyed into at least one gap (8), wherein high wall shear stresses (9) are generated and sludge components, such as polymers, enzymes, extracellular substances and/or microorganisms, are intensively mixed into the suspension in a hydrodynamic way, such that a substantially homogeneous suspension is resulting at exit of the gap.

2. Method according to claim 1, characterized in that the device is formed of at least two stages, wherein one stage of said at least two stages is formed for disagglomeration, such that the flow is deflected at least once without changing average flow velocity, and the particles hit a wall at the location of deflection, such that the agglomerates are destroyed, their surface area is increased, and they are mixed into the suspension by hydrodynamic releasing vortexes at the location of deflection, and subsequently the sludge suspension is conveyed into other stage of said at least two stages for homogenization in at least one gap, wherein high wall shear stresses are generated and the sludge components, such as for example the polymers and/or the microorganisms, are intensively mixed into the suspension in a hydrodynamic way, such that a homogenous suspension is resulting at the exit of the gap.

3. Method according to claim 1, characterized in that the sludge suspension is deflected between 2 to 5 times in a stage in order to achieve almost a complete destruction of the sludge agglomerates in a single flow-through.

4. Method according to claim 1, characterized in that the device is formed of a stage which is composed of a gap, which advantageously has a width to length ratio of at least 1 to 10 in order to increase the effect of mixing by means of the wall shear stress.

5. Method according to claim 1, characterized in that the device is formed of a stage and a tube is utilized in the stage, inner wall of which is designed or pre-treated such that micro-vortexes emerge during the flow-through, wherein the micro-vortexes result in a destruction of the agglomerates, and subsequently the sludge suspension is conveyed into another stage by the pressure generator.

6. Method according to claim 1, characterized in that the device is formed of at least one stage which is formed as a receiver container having at least one mixing means and that the sludge suspension is conveyed into another stage by the pressure generator.

7. Method according to claim 1, characterized in that the device is formed of at least one stage which is composed of an outer and an inner part, wherein the inner part and/or the outer part is movably supported, such that flow-through area automatically adapts to different sludge volume flows.

8. Method according to claim 1, characterized in that the device is formed of at least one stage which is composed of an outer and inner part, wherein the inner part and/or the outer part is adjusted in axial direction in mechanical, electrical, hydraulic or pneumatic way such that a pre-pressure is applied to the sludge suspension or such that movable part acts as a closure of the stage in case of no flow-through.

9. Method according to claim 1, characterized in that the flow is deflected multiple times, wherein at least one stage is formed with at least one location of deflection arranged concentrically around supply opening and at least terminates in an annular gap functioning as a further stage.

10. Method according to claim 1, characterized in that the device is formed of at least one stage in which the wall shear stresses for homogenization of the sludge suspension are increased by a decrease of ratio of flow-through area to wetted area.

11. Method according to claim 1, characterized in that the device is formed of at least one stage and flow-through velocity in the at least one stage is at least doubled, wherein flow-through area is reduced in flow-through direction and the stage is advantageously formed as an annular gap.

12. Method according to claim 1, characterized in that the sludge suspension is abruptly relaxed at exit of at least one stage, thereby achieving a higher homogenization degree of the suspension.

13. Method according to claims claim 1, characterized in that sludges, viscosity of which is more than 5 times than that of water, are passed through the device at least twice for homogenizing the sludge suspension.

14. Method according to claim 1, characterized in that sludges having a non-NEWTON flow behavior are passed through the device at least twice for homogenization.

15. Method according to claim 1, characterized in that for sludges having a thixotropic behavior, the sludge suspension is passed multiple times, preferably at least 5 times, through the device for homogenization to prolong the time for return to original viscosity.

16. Method according to claim 1, characterized in that in sludges having thixotropic behavior, for preventing a recovery to original viscosity after treatment unit, which is composed of at least one inflow and/or outflow line with the interposed device, at least one mixing container having at least one mixing means is connected downstream the treatment unit.

17. Method according to claim 1, characterized in that, for a sludge suspension having a thixotropic behavior, a recovery of original viscosity is prevented by designing one stage such that at downstream end of the one stage vapor pressure of carrier liquid is undershot and implosion of gas bubbles results in a partial or a complete destruction of the extracellular and polymeric substances.

18. Method according to claim 1, characterized in that the pressure generator is controlled in dependency of input, output or differential pressure of the device for homogenization of the sludge suspension.

19. Method according to claim 1, characterized in that the pressure generator is controlled in dependency of volume flow through the device for homogenization of the sludge suspension.

20. Method according to claim 1, characterized in that only a partial flow of an organic sludge suspension is homogenized and this is mixed to an untreated sludge suspension as a seed sludge in order to increase the conversion rate of the organic components.

21. Apparatus for performing the method according to claim 1, comprising the pressure generator and a treatment unit having a supply and/or discharge opening, characterized in that the apparatus has at least two stages in which disagglomeration and homogenization take place.

22. Apparatus according to claim 1, characterized in that the apparatus has two stages, wherein disagglomeration is effected in the first stage in flow direction by deflecting the sludge suspension, and homogenization is effected in the second stage upon flow-through by high wall shear stresses.

23. Apparatus according to claim 1, characterized in that the apparatus has at least one stage, in which the sludge suspension is deflected by at least one angle in supply and/or discharge channel.

24. Apparatus according to claim 1, characterized in that the apparatus has at least one stage, in which at least one tube is utilized, which is formed to permanently deflect the sludge suspension in its direction.

25. Apparatus according to claim 1, characterized in that the apparatus has at least one stage in which at least one spiral tube is utilized, in which the sludge suspension receives a twist impulse and thereby the agglomerates hit the tube wall, are destroyed and mixed.

26. Apparatus according to claim 1, characterized in that the apparatus has at least one stage having at least one zigzagged tube, in which the sludge suspension hits the tube wall upon each change of direction, and thereby the agglomerates are destroyed and mixed into the sludge suspension.

27. Apparatus according to claim 1, characterized in that the apparatus has at least one stage in which at least one tube is utilized, the inner wall of which is designed or pre-treated such that during flow-through micro- and macro-vortexes are created, resulting in a destruction of the agglomerates.

28. Apparatus according to claim 1, characterized in that the apparatus has at least one stage, angle of which varies at each deflection point between inflow and outflow channel.

29. Apparatus according to claim 1 used for NEWTON flow behavior of a sludge suspension with a viscosity of less than 5 times than that of water, characterized in that the apparatus has at least one stage in which angle between inflow and outflow channel is between 80° and 110°, preferably about 90°.

30. Apparatus according to claim 1 used for a sludge suspension with non-NEWTON and/or thixotropic flow behavior, characterized in that the apparatus has at least one stage in which at least three deflection points are provided and first angle between inflow and outflow channel is at least 1500 and/or second angle is at least 120° and/or third angle is at least 90°.

31. Apparatus according to claim 1, characterized in that the apparatus has at least one stage composed of an outer and an inner part, wherein the inner part and/or the outer part is displaceably arranged such that flow-through area is variable.

32. Apparatus according to claim 1, characterized in that the apparatus has at least one stage which extends concentrically around the supply opening for the sludge suspension and subsequently transitions into an annular gap, wherein average flow-through velocity remains the same in cross-sectional (flow-through) areas.

33. Apparatus according to claim 1, characterized in that the apparatus has stages which are combined in one stage, wherein the stage consists of an outer and an inner part, wherein at least one of these parts is designed such that a deflection of the sludge suspension from the flow axis as well as a mixing by wall shear stresses are effected.

34. Apparatus according to claim 1, characterized in that the apparatus has at least another stage which is designed as unique, multiple or surrounding gap, wherein the cross-section can be composed of drawn tubes and solid materials, for example of circular, ellipsoidal, square, rectangular or polygon-shaped cross-section.

35. Apparatus according to claim 1, characterized in that the apparatus has at least one stage which is composed of an outer and inner part displaceably arranged to each other, and that at least the inner part constitutes a pressure plate, such that the distance between the outer and inner part is varied by the flow pressure.

36. Apparatus according to claim 1, characterized in that the apparatus has at least one stage which is composed of an outer and an inner part displaceably arranged to each other, and the inner part forms a pressure plate, wherein volume flow and/or viscosity and/or solid content or combinations thereof are detected by a sensor as a control variable, and wherein in dependency of the control variable distance between the outer and inner part is adjusted in a mechanical, electrical, pneumatic or hydraulic way.

37. Apparatus according to claim 1, characterized in that the apparatus has at least another stage which is formed for example as a segmented gap or annular gap in order to advantageously further lower the ratio of flow-through area to wetted area and thus to increase the influence of the wall shear stresses for homogenization.

38. Apparatus according to claim 1, characterized in that the apparatus has at least another stage which is formed for example as a segmented annular gap with at least two segments, wherein flow-through area steadily decreases in flow-through direction, such that it forms nozzles resulting in almost complete mixing of the sludge suspension.

39. Apparatus according to claim 1, characterized in that cross-sectional variation results in undershooting the vapor pressure of the carrier liquid, and thereby resulting in gas bubbles, wherein subsequent implosion of the gas bubbles results in a higher homogenization degree.

40. Apparatus according to claim 1, characterized in that the apparatus has at least another stage which is formed such that it comprises at least two zones in flow-through direction, wherein a relaxation of the sludge suspension occurs by means of cross-sectional extension between the two zones, and thus additional hydro-mechanical vortexes are induced for improved mixing into carrier liquid.

41. Apparatus according to claim 1, characterized in that with non-NEWTON and/or thixotropic flow behavior the apparatus has at least one stage which is formed such that it comprises at least two zones in flow-through direction, wherein the vapor pressure of carrier liquid is undershot by cross-sectional variation at the end of the first zone, and in the subsequent second zone an abrupt relaxation results by means of a cross-sectional extension, such that gas bubbles implosion is used as an additional homogenization mechanism.

42. Apparatus according to claim 1, characterized in that at least two of the treatment units are connected one behind the other, such that their individual effects are enhanced in synergistic manner and thereby a particularly intensive destruction of the sludge agglomerates and thus a particularly good homogenization of the sludge suspension is achieved.

43. Apparatus according to claim 1, characterized in that the apparatus includes a treatment unit which is formed as an intermediate flange connection.

44. Apparatus according to claim 1, characterized in that the apparatus includes a treatment unit which is formed as an intermediate flange connection and is provided with at least one compensator for vibration absorption.
